(19) United States
(12) Patent Application Publication
(10) Pub. No.: US 2026/0158875 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Minseob Shin, Hwaseong-si (KR); Eon Soo Yun, Hwaseong-si (KR); Tae Hee Kim, Hwaseong-si (KR); Yong Woong Cha, Hwaseong-si (KR); Seong-Bin Jeong, Hwaseong-si (KR)

(73) Assignees: HYUNDAI MOTOR COMPANY, Seoul (KR); KIA CORPORATION, Seoul (KR)

(21) Appl. No.: 19/236,393

(22) Filed: Jun. 12, 2025

(30) Foreign Application Priority Data
Dec. 6, 2024 (KR) 10-2024-0181008

(51) Int. Cl. B60H 1/32; B60H 1/00

(52) U.S. Cl. CPC B60H 1/32284; B60H 1/00278

(57) ABSTRACT

A heat pump system for a vehicle is provided to improve the overall cooling and heating performance and efficiency by increasing the enthalpy difference of the evaporator or chiller to be significantly large at the time of cooling or heating vehicle interior. The heat pump system further improves the overall cooling and heating performance by heating the vehicle interior by using a high-temperature coolant, and by removing the conventional heat-exchanger applied for subcooling of the refrigerant. The heat pump system is further configured to exchange heat between refrigerants having different temperatures, and is additionally configured to employ a heat-exchanger configured to exchange heat between the coolant and the refrigerant.

### CROSS-REFERENCE TO RELATED APPLICATION

This application claims priority to and the benefit of Korean Patent Application No. 10-2024-0181008 filed with the Korean Intellectual Property Office on Dec. 6, 2024, the entire contents of which is incorporated herein by reference.

### BACKGROUND

### Technical Field

The present disclosure relates to a heat pump system for a vehicle, and more particularly, the present disclosure relates to a heat pump system for a vehicle capable of improving the overall cooling and heating performance and efficiency by heating the vehicle interior by using a high-temperature coolant, and reducing the pressure drop of the refrigerant at the time of cooling or heating a vehicle interior.

### Description of the Related Art

An air conditioning system for a vehicle includes an air conditioner unit circulating a refrigerant in order to heat or cool an interior of a vehicle.

The air conditioner unit, which maintains the interior of the vehicle at an appropriate temperature regardless of a change in an external temperature to maintain a comfortable interior environment, is configured to heat or cool the interior of the vehicle by exchanging heat by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

In accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

In an electric vehicle or a hybrid vehicle among these environment-friendly vehicles, a separate heater is not used unlike an air conditioner of a general vehicle, and an air conditioner used in an environment-friendly vehicle is generally called a heat pump system.

An electric vehicle driven by the power source of a fuel cell generates driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, a hybrid vehicle generates driving force by driving a motor using electricity supplied from the fuel cell described above or an electrical battery, together with an engine operated by a general fuel, such as gasoline. Therefore, heat generated from the fuel cell or the battery and the motor should be effectively removed in order to secure performance of the motor.

Therefore, in a hybrid vehicle or an electric vehicle according to the related art, a cooling means, a heat pump system, and a battery cooling system, respectively, should be configured as separate closed circuits so as to prevent heat generation of the motor, an electric component, and the battery including a fuel cell.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort of the vehicle.

In order to increase the condensation rate of the refrigerant, conventional heat pump systems employ a heat-exchanger configured to exchange heat between a low-temperature and low-pressure refrigerant supplied from the evaporator and a high-temperature and high-pressure refrigerant supplied from the condenser.

However, such a heat-exchanger causes a pressure drop of the refrigerant introduced into the evaporator, which decreases the suction pressure and density of the compressor, thereby resulting in drawbacks in that the overall flow rate of the refrigerant flowing in a conventional heat pump system decreases, and the cooling and heating performance and efficiency deteriorates as well.

In addition, in order to improve the cooling and heating efficiency of the vehicle interior, the compressor needs to be excessively operated, so that there is a disadvantage in that the required power of the compressor increases, and the power consumption also increases.

The above information disclosed in this Background section is only for enhancement of understanding of the background of the disclosure, and therefore it may contain information that does not form the prior art that is already known to a person having ordinary skill in the art.

### SUMMARY

The present disclosure provides a heat pump system for a vehicle capable of improving the overall cooling and heating performance and efficiency by increasing the enthalpy difference of the evaporator or chiller to be significantly large at the time of cooling or heating vehicle interior. The heat pump system improves the overall performance by heating the vehicle interior by using a high-temperature coolant and by removing the conventional heat-exchanger applied for subcooling of the refrigerant and configured to exchange heat between refrigerants having different temperature, and additionally employ a heat-exchanger configured to heat-exchange the coolant and the refrigerant.

A heat pump system for a vehicle includes a compressor configured to compress a refrigerant. The heat pump system further includes an HVAC module including a heater core and an evaporator connected to the compressor through a refrigerant line, and also including an opening/closing door configured to adjust air having passed through the evaporator to be selectively introduced into the heater core based on a cooling mode or a heating mode of a vehicle interior. The heat pump system further includes a condenser connected to the compressor through the refrigerant line, and configured to condense the refrigerant. The heat pump system further includes a heat-exchanger connected to the condenser through the refrigerant line, and configured to exchange heat between a coolant and the refrigerant. The heat pump system further includes a first expansion valve disposed between the heat-exchanger and the evaporator and connected to the heat-exchanger and the evaporator through the refrigerant line. The heat pump system further includes a connection line having a first end connected to the refrigerant line between the heat-exchanger and the first expansion valve, and a second end connected to the refrigerant line between the evaporator and the compressor. The heat pump system further includes a chiller provided on the connection line and configured to adjust a temperature of the coolant by exchanging heat between the coolant and the refrigerant. The heat pump system further includes an electrical component cooling apparatus connected to the condenser through a first coolant line, and enabling a first coolant to flow along the first coolant line, where the electrical component cooling apparatus may be connected to the heat-exchanger and the chiller, respectively, through a second coolant line, so that the first coolant is selectively supplied to the heat-exchanger and the chiller.

The heat-exchanger may be integrally configured with the condenser.

The refrigerant flowing from the compressor along the refrigerant line sequentially passes through the condenser and the heat-exchanger.

The heat pump system may further include a second expansion valve provided on the connection line at an upstream end of the chiller. The heat pump system may further include a battery module connected to the heat-exchanger and the chiller through a third coolant line, and selectively enabling the second coolant to flow through the third coolant line, where the heater core is connected to the condenser through a fourth coolant line, and enabling a third coolant to selectively flow along the fourth coolant line.

In a cooling mode of the vehicle interior, a portion of the refrigerant line interconnecting the compressor, the condenser, the heat-exchanger, the first expansion valve, and the evaporator may be opened. The connection line may be opened by the second expansion valve. The first coolant line may be opened so that the first coolant is supplied to the condenser. The second coolant line may be closed. The third coolant line may be opened, so that the second coolant is supplied to the heat-exchanger, the chiller, and the battery module. The fourth coolant line may be closed. The first expansion valve may expand the refrigerant introduced through the refrigerant line and may supply the expanded refrigerant to the evaporator. The second expansion valve may expand the refrigerant introduced through the connection line and may supply the expanded refrigerant to the chiller.

The heat-exchanger may heat-exchange the second coolant supplied from the battery module through the third coolant line with the refrigerant, and the chiller may supply the second coolant cooled through heat-exchange with the refrigerant to the battery module through the third coolant line.

In a heating mode of the vehicle interior, a portion of the refrigerant line connecting the compressor, the condenser, and the heat-exchanger may be opened. A portion of the refrigerant line connecting the first end of the connection line and the evaporator, and a portion of the refrigerant line connecting the evaporator and the second end of the connection line may be closed by the first expansion valve. The connection line may be opened by the second expansion valve. The first coolant line may be closed. The second coolant line may be opened so that the first coolant is supplied to the condenser and the chiller. The third coolant line may be closed. The fourth coolant line may be opened. The first expansion valve may stop operating. The second expansion valve may expand the refrigerant introduced through the connection line and may supply the expanded refrigerant to the chiller.

The condenser may supply the third coolant whose temperature is increased through heat-exchange with the refrigerant to the heater core through the fourth coolant line.

The heat-exchanger and the chiller may recollect an ambient air heat and a waste heat of the electrical component while heat-exchanging the first coolant supplied from the electrical component cooling apparatus through the second coolant line with the refrigerant.

The heat-exchanger may additionally condense the refrigerant condensed in the condenser while heat-exchanging the first coolant supplied from the electrical component cooling apparatus through the second coolant line with the refrigerant supplied from the condenser.

The chiller may evaporate the refrigerant while heat-exchanging the first coolant supplied from the electrical component cooling apparatus through the second coolant line with the refrigerant, and may supply the evaporated refrigerant to the compressor.

The condenser may be a water-cooled heat-exchanger inside which the first coolant or a third coolant flow.

The heat-exchanger and the chiller may be water-cooled heat-exchangers in which the first coolant or a second coolant flows.

The second expansion valve may be an electronic expansion valve configured to selectively expand the refrigerant while controlling the flow of the refrigerant.

The heat pump system may further include an accumulator provided on the refrigerant line between the evaporator and the compressor.

As described above, according to a heat pump system for a vehicle according to an embodiment of the present disclosure, the vehicle interior may be heated by using a high-temperature coolant, and for subcooling of the refrigerant, a heat-exchanger configured to heat-exchange the coolant and the refrigerant may be employed instead of the conventional heat-exchanger configured to heat-exchange refrigerants having different temperatures, to increase the enthalpy difference of the evaporator or chiller to be significantly large at the time of cooling or heating vehicle interior, thereby improving the overall cooling and heating performance and efficiency.

In addition, according to the present disclosure, by reducing the pressure drop of the refrigerant at the time of cooling or heating, the overall flow rate of the refrigerant flowing in the system may be increased, thereby improving the efficiency and performance of the system.

In addition, according to the present disclosure, the thermal energy generated from the refrigerant when condensing the refrigerant may be selectively heat-exchanged with the coolant, and the vehicle interior may be more efficiently heated by using the heat-exchanged high-temperature coolant.

In addition, according to the present disclosure, by selectively using the ambient air heat, the waste heat of the electrical component, and the waste heat of the battery module when heating the vehicle interior, the heating efficiency of the vehicle may be improved, and by efficiently adjusting the temperature of the battery module so that the optimal performance of the battery module may be achieved, the overall travel distance of the vehicle may be increased.

In addition, according to the present disclosure, due to streamlining of the entire system, it is possible to reduce the overall manufacturing cost and weight, and improve space utilization by minimizing the number of components.

### BRIEF DESCRIPTION OF THE DRAWINGS

FIG. 1 is a block diagram illustrating a heat pump system for a vehicle according to an embodiment of the present disclosure.

FIG. 2 is an operation diagram according to a cooling mode of the vehicle interior of a heat pump system for a vehicle according to an embodiment of the present disclosure.

FIG. 3 is an operation diagram according to a heating mode of the vehicle interior of a heat pump system for a vehicle according to an embodiment of the present disclosure.

### DETAILED DESCRIPTION OF THE EMBODIMENTS

Embodiments of the present disclosure are hereinafter described in detail with reference to the accompanying drawings.

Embodiments of the present disclosure disclosed in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the words “comprise”, “have”, “include”, and variations thereof such as “comprises” or “comprising”, should be understood to imply the inclusion of stated elements but not the exclusion of any other elements.

Furthermore, each of terms, such as “. . . unit”, “. . . means”, “. . . portions”, “. . . part”, and “. . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

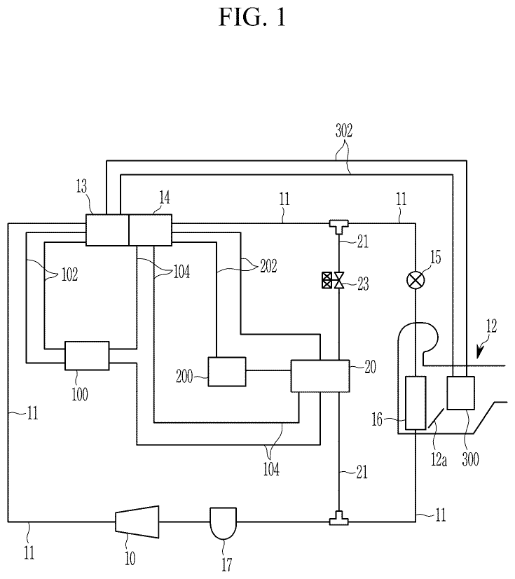

FIG. 1 is a block diagram illustrating a heat pump system for a vehicle according to an embodiment of the present disclosure.

According to a heat pump system for the vehicle according to an embodiment of the present disclosure, a vehicle interior may be heated by using a high-temperature coolant, the conventional heat-exchanger configured to heat-exchange refrigerants having different temperatures applied for subcooling of the refrigerant may be removed, and by additionally employing a water-cooled heat-exchanger configured to heat-exchange the coolant and the refrigerant, the enthalpy difference of an evaporator 16 or a chiller 20 may be increased to be significantly large at the time of cooling or heating the vehicle interior, thereby improving the overall cooling and heating performance and efficiency of the system.

Referring to FIG. 1, the heat pump system may include a compressor 10, a heating, ventilation, and air-conditioning (HVAC) module 12, a condenser 13, a heat-exchanger 14, a first expansion valve 15, the evaporator 16, the chiller 20, a connection line 21, and a second expansion valve 23, through which the refrigerant circulates, and an electrical component cooling apparatus 100, a battery module 200, and a heater core 300, through which the coolant circulates.

The compressor 10 may compress the introduced refrigerant and allow the compressed refrigerant to flow along the refrigerant line 11 so that the refrigerant circulates along the refrigerant line 11.

In an embodiment of the present disclosure, the HVAC module 12 may be internally provided with the evaporator 16 connected through the refrigerant line 11, and the heater core 300 to which a high-temperature third coolant is selectively supplied.

An opening/closing door 12a (i.e., a door configured to be opened and closed) configured to adjust an ambient air having passed through the evaporator 16 to be selectively introduced into the heater core 300 may be provided inside an interior of the HVAC module 12 between the evaporator 16 and the heater core 300.

When heating the vehicle interior, the opening/closing door 12a may be opened so that the ambient air having passed through the evaporator 16 is introduced into the heater core 300.

In other words, the high-temperature third coolant supplied to the heater core 300 may increase the temperature of the ambient air passing through the heater core 300. In other words, the introduced ambient air may be converted into a high-temperature state while passing through the heater core 300 and then introduced into the vehicle interior, thereby implementing heating of the vehicle interior.

At the time of cooling the vehicle interior, the opening/closing door 12a may close a side toward the heater core 300 so that the ambient air cooled while passing through the evaporator 16 is directly introduced into the vehicle interior.

Accordingly, the ambient air passing through the evaporator 16 may be cooled while passing through the evaporator 16 by a low-temperature refrigerant supplied to the evaporator 16. The cooled ambient air may be introduced into the vehicle interior, thereby cooling the vehicle interior.

In an embodiment of the present disclosure, the condenser 13 may be connected to the compressor 10 through the refrigerant line 11.

The electrical component cooling apparatus 100 may be connected to the condenser 13 through a first coolant line 102. The electrical component cooling apparatus 100 may allow the first coolant to flow along the first coolant line 102.

In an embodiment of the present disclosure, the electrical component cooling apparatus 100 may include a radiator and an electrical component. The electrical component may include an electrical power control apparatus, or an inverter, or an on-board charger (OBC).

The electrical component cooling apparatus 100 configured as such may supply the first coolant cooled in the radiator to the electrical component. In addition, the electrical component cooling apparatus 100 may supply the first coolant to the condenser 13 through the first coolant line 102.

A water pump (not shown) may be provided on the first coolant line 102. In other words, the first coolant may circulate along the first coolant line 102 according to an operation of a water pump (not shown) (i.e., the water pump imparts flow of the coolant through the coolant lines).

Accordingly, the condenser 13 may condense the refrigerant by using the first coolant supplied from the electrical component cooling apparatus 100 through the first coolant line 102.

In an embodiment of the present disclosure, the heat-exchanger 14 may be connected to the condenser 13 through the refrigerant line 11. The heat-exchanger 14 may be integrally configured with the condenser 13. The heat-exchanger 14 may exchange heat between the selectively introduced coolant and the refrigerant.

Accordingly, the refrigerant flowing from the compressor 10 along the refrigerant line 11 may sequentially pass through the condenser 13 and the heat-exchanger 14.

In an embodiment of the present disclosure, the first expansion valve 15 may be provided on the refrigerant line 11 connecting the heat-exchanger 14 and the evaporator 16. The first expansion valve 15 may selectively expand the introduced refrigerant.

The first expansion valve 15 may be a mechanical expansion valve configured to expand the refrigerant introduced through the refrigerant line 11.

An embodiment of the present disclosure takes an example in which the first expansion valve 15 is a mechanical expansion valve, but is not limited thereto, and the first expansion valve 15 may be an electronic expansion valve configured to selectively expand the refrigerant while controlling the flow of the supplied refrigerant.

The heat pump system may further include an accumulator 17 provided on the refrigerant line 11 between the evaporator 16 and the compressor 10. The accumulator 17 may supply only a gaseous refrigerant to the compressor 10, thereby improving the efficiency and durability of the compressor 10.

In addition, the chiller 20 may be provided on the connection line 21, so as to adjust a temperature of the coolant by exchanging heat between the selectively introduced coolant and the refrigerant.

A first end of the connection line 21 may be connected to the refrigerant line 11 between the heat-exchanger 14 and the first expansion valve 15. A second end of the connection line 21 may be connected to the refrigerant line 11 between the evaporator 16 and the compressor 10.

In more detail, the second end of the connection line 21 may be connected to the refrigerant line 11 between the evaporator and the accumulator 17.

In addition, the second expansion valve 23 may be provided on the connection line 21 at an upstream end of the chiller 20, based on the flow direction of the refrigerant.

The second expansion valve 23 may be an electronic expansion valve configured to selectively expand the refrigerant while controlling the flow of the supplied refrigerant.

The second expansion valve 23 may be disposed at the upstream end of the chiller 20 based on the flow direction of the refrigerant flowing along the connection line 21, so that the chiller 20 may be introduced before being supplied to the refrigerant.

In other words, the upstream end of the chiller 20 may be set based on the flow direction of the refrigerant. Based on the direction in which the refrigerant flows along the connection line 21, the location where the refrigerant is introduced into the chiller 20 may be defined as an upstream end of the chiller 20, and the location where the refrigerant is discharged from the chiller 20 may be defined as a downstream end of the chiller 20.

The electrical component cooling apparatus 100 may be connected to the heat-exchanger 14 and the chiller 20 through a second coolant line 104, so that the first coolant is selectively supplied to the heat-exchanger 14 and the chiller 20, respectively.

A water pump (not shown) may be provided on the second coolant line 104. In other words, the first coolant may circulate along the second coolant line 104 according to the operation of a water pump (not shown).

Accordingly, the heat-exchanger 14 may exchange heat between the first coolant selectively introduced through the second coolant line 104 and the supplied refrigerant, to additionally condense the refrigerant condensed in the condenser 13.

In addition, the chiller 20 may exchange heat between the first coolant selectively introduced through the second coolant line 104 and the selectively supplied refrigerant, to adjust the temperature of the coolant, and to evaporate the refrigerant.

In other words, the heat-exchanger 14 and the chiller 20 may recollect a waste heat of the electrical component while exchanging heat between the first coolant introduced through the second coolant line 104 from the electrical component cooling apparatus 100 and the refrigerant, or may cool the electrical component by using the first coolant heat-exchanged with the refrigerant.

In an embodiment of the present disclosure, the battery module 200 may be connected to the heat-exchanger 14 and the chiller 20 through a third coolant line 202. The battery module 200 may selectively allow the second coolant to flow through the third coolant line 202.

A water pump (not shown) may be provided on the third coolant line 202. In other words, the second coolant may circulate along the third coolant line 202 according to the operation of a water pump (not shown).

In other words, the heat-exchanger 14 and the chiller 20 may exchange heat between the second coolant introduced through the third coolant line 202 from the battery module 200 and the refrigerant, to recollect the waste heat of the battery module 200, or may cool the battery module 200 by using the second coolant that exchanged heat with the refrigerant.

The heat-exchanger 14 and the chiller 20 may exchange heat between the introduced refrigerant and the first coolant selectively introduced into the second coolant line 104 or the second coolant selectively introduced into the third coolant line 202.

In other words, the heat-exchanger 14 and the chiller 20 may be a water-cooled heat-exchanger in which the first coolant or the second coolant flows.

Accordingly, the heat-exchanger 14 may additionally exchange heat between the first coolant or the second coolant and the refrigerant, to further lower the temperature of the refrigerant and increase the condensation degree.

As such, the heat-exchanger 14 may further condense the refrigerant condensed in the condenser 13, so as to increase the sub-cooling of the refrigerant and thereby to increase the condensation degree of the refrigerant.

In other words, in an embodiment of the present disclosure, instead of a conventional heat-exchanger that exchanges heat between refrigerants of different temperatures, the heat-exchanger 14 is configured to exchange heat between the coolant and the refrigerant, so that the pressure drop of the refrigerant discharged from the evaporator 16 is reduced.

As such, when the pressure drop of the refrigerant is decreased, the heat pump system may prevent the suction pressure and density of the compressor 10 from being decreased, and may prevent the total flow rate of the refrigerant flowing along the refrigerant line 11 from being decreased.

In addition, the heat-exchanger 14 may subcool the refrigerant and supply the subcooled refrigerant to the evaporator 16 or the chiller 20, thereby lowering the temperature of the refrigerant on an inlet side of the evaporator 16 or the chiller 20.

When the temperature of the refrigerant on the inlet side of the evaporator 16 or the chiller 20 is lowered, the heat pump system may have the enthalpy difference of the evaporator 16 or the chiller 20 to be significantly large, so that the coefficient of performance (COP), which is a coefficient of cooling capability compared to a required compressor power, may be improved, and the overall performance and efficiency may be improved compared to a conventional scheme.

In an embodiment of the present disclosure, the heater core 300 may be connected to the condenser 13 through a fourth coolant line 302. The heater core 300 may allow the third coolant to selectively flow along the fourth coolant line 302.

A water pump (not shown) may be provided on the fourth coolant line 302. In other words, the third coolant may circulate along the fourth coolant line 302 according to the operation of a water pump (not shown).

Accordingly, in a heating mode of the vehicle interior, the condenser 13 may exchange heat between the third coolant flowing along the fourth coolant line 302 and a high-temperature refrigerant supplied from the compressor 10 to condense the refrigerant, and to increase the temperature of the third coolant.

The third coolant whose temperature is increased while passing through the condenser 13 may be supplied to the heater core 300 along the fourth coolant line 302, thereby heating the vehicle interior.

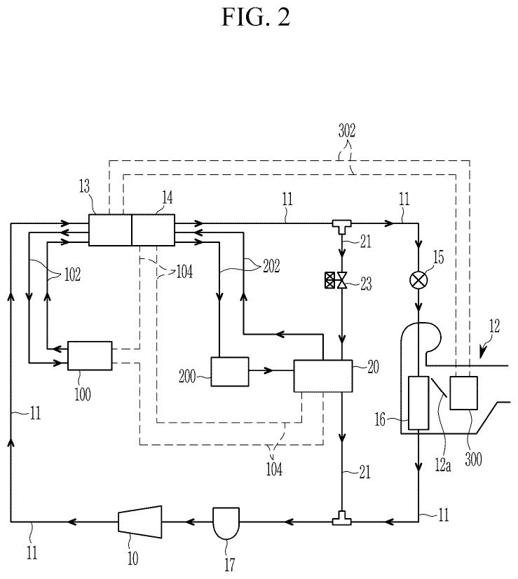

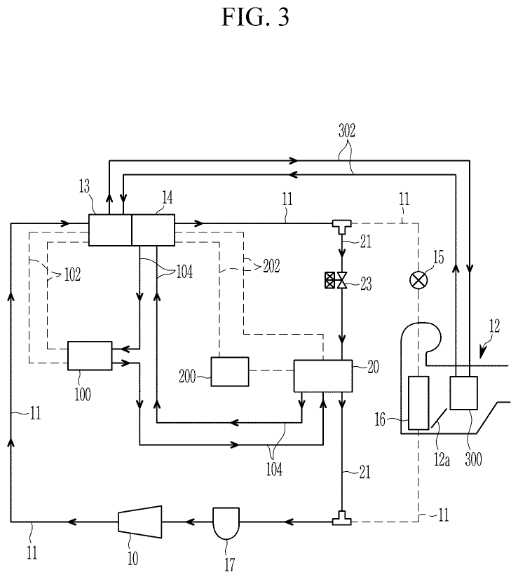

Hereinafter, an operation and action of a heat pump system for the vehicle according to an embodiment of the present disclosure configured as described above is described in detail below with reference to FIG. 2 and FIG. 3.

According to an embodiment of the present disclosure, an operation in a cooling mode of the vehicle interior is described in detail below with reference to FIG. 2.

FIG. 2 is an operation diagram of a heat pump system for the vehicle according to an embodiment of the present disclosure, for the cooling mode of the vehicle interior.

Referring to FIG. 2, in the cooling mode of the vehicle interior, the refrigerant line 11 interconnecting the compressor 10, the condenser 13, the heat-exchanger 14, the first expansion valve 15, and the evaporator 16 may be opened.

In such a state, when cooling of the battery module 200 is required, the connection line 21 may be opened by the second expansion valve 23.

The electrical component cooling apparatus 100 may open the first coolant line 102 so that the first coolant is the supplied to the condenser 13.

In addition, the second coolant line 104 may be closed by the electrical component cooling apparatus 100.

Accordingly, the first coolant cooled in a radiator (not shown) may be supplied from the electrical component cooling apparatus 100 to the condenser 13 through the first coolant line 102.

The third coolant line 202 may be opened, so that the second coolant is supplied to the heat-exchanger 14, the chiller 20, and the battery module 200.

In addition, the fourth coolant line 302 may be closed. Accordingly, the third coolant may not be supplied to the heater core 300.

In such a state, the refrigerant compressed in the compressor 10 may be introduced into the condenser 13 along the refrigerant line 11.

The condenser 13 may condense the refrigerant by using the first coolant supplied from the electrical component cooling apparatus 100 through the first coolant line 102.

The refrigerant condensed in the condenser 13 may be introduced into the heat-exchanger 14. The heat-exchanger 14 may exchange heat between the second coolant supplied from the battery module 200 through the third coolant line 202 and the refrigerant, to additionally condense the refrigerant.

A partial refrigerant among the refrigerant additionally condensed in the heat-exchanger 14 may be introduced into the second expansion valve 23 along the connection line 21.

The second expansion valve 23 may expand the refrigerant introduced through the connection line 21 and supply the expanded refrigerant to the chiller 20.

The refrigerant introduced into the chiller 20 may cool the second coolant while being heat-exchanged with the second coolant supplied from the battery module 200 through the third coolant line 202.

The second coolant cooled in the chiller 20 may pass through the heat-exchanger 14 along the third coolant line 202, to be supplied to the battery module 200. In other words, the chiller 20 may supply the second coolant cooled through exchanging heat with the refrigerant to the battery module 200 through the third coolant line 202.

Accordingly, the battery module 200 may be efficiently cooled by the second coolant cooled in the chiller 20.

In other words, the second coolant circulating through the third coolant line 202 may efficiently cool the battery module 200 while repeatedly performing the above-described operation.

A remaining refrigerant among the refrigerant additionally condensed in the heat-exchanger 14 may be introduced into the first expansion valve 15 along the refrigerant line 11.

The first expansion valve 15 may expand the refrigerant introduced through the refrigerant line 11 and supply the expanded refrigerant to the evaporator 16.

In such a state, the ambient air introduced into the HVAC module 12 may be cooled by the low-temperature refrigerant introduced into the evaporator 16 while passing through the evaporator 16.

The opening/closing door 12a may close a portion heading to the heater core 300 so that the cooled ambient air does not pass through the heater core 300. Therefore, the cooled ambient air may cool the vehicle interior by being directly introduced into the vehicle interior.

In addition, the refrigerant having passed through the chiller 20 may be introduced into the accumulator 17 together with the refrigerant discharged from the evaporator 16. Thereafter, the refrigerant may pass through the accumulator 17, to be introduced into the compressor 10.

In other words, in the heat pump system, the heat-exchanger 14 may use the second coolant in order to additionally condense the refrigerant, so that the pressure drop of the refrigerant discharged from the evaporator 16 and the chiller 20 may be reduced compared to the conventional heat-exchanger exchanging heat between refrigerants having different temperatures.

As such, when the pressure drop of the refrigerant is decreased, the heat pump system may prevent the suction pressure and density of the compressor 10 from being decreased, and may prevent the total flow rate of the refrigerant flowing along the refrigerant line 11 from being decreased.

In addition, the heat-exchanger 14 may subcool the refrigerant condensed in the condenser 13 through exchanging heat with the second coolant, and supply the subcooled refrigerant to the evaporator 16 and the chiller 20, respectively, so that the temperature of the refrigerant on the inlet side of the evaporator 16 or the chiller 20 can be lowered.

When the temperature of the refrigerant on the inlet side of the evaporator 16 or the chiller 20 is lowered, the heat pump system may have the enthalpy difference of the evaporator 16 or the chiller 20 to be significantly large, so that the coefficient of performance (COP), which is a coefficient of cooling capability compared to a required compressor power, may be improved, and the overall cooling performance and cooling efficiency may be improved compared to a conventional scheme.

In addition, in an embodiment of the present disclosure, an operation in the heating mode of the vehicle interior is described in detail below with reference to FIG. 3.

FIG. 3 is an operation diagram according to the heating mode of the vehicle interior in a heat pump system for the vehicle according to an embodiment of the present disclosure.

Referring to FIG. 3, in the heating mode of the vehicle interior, a portion of the refrigerant line 11 may be opened, so that the compressor 10, the condenser 13, and the heat-exchanger 14 are interconnected through the refrigerant line 11.

The portion of the refrigerant line 11 connecting the first end of the connection line 21 and the evaporator 16, and the portion of the refrigerant line 11 connecting the evaporator 16 and the second end of the connection line 21, may be closed by the first expansion valve 15.

Operation of the first expansion valve 15 may be stopped. Accordingly, the refrigerant may not be supplied to the evaporator 16.

The connection line 21 may be opened by the second expansion valve 23.

The electrical component cooling apparatus 100 may close the first coolant line 102. At the same time, the electrical component cooling apparatus 100 may open the second coolant line 104 so that the first coolant is the supplied to the heat-exchanger 14 and the chiller 20.

Accordingly, the first coolant having passed through the radiator (not shown) and the electrical component may pass through the chiller 20 through the second coolant line 104 from the electrical component cooling apparatus 100, and then pass through the heat-exchanger 14.

The third coolant line 202 may be closed. In addition, the fourth coolant line 302 may be opened so that the third coolant may circulate through the condenser 13 and the heater core 300.

In such a state, the refrigerant compressed in the compressor 10 may be introduced into the condenser 13 along the refrigerant line 11.

The condenser 13 may condense the refrigerant by using the third coolant supplied from the heater core 300 through the fourth coolant line 302.

Accordingly, the refrigerant introduced into the condenser 13 may be condensed while exchanging heat with the third coolant supplied from the heater core 300 through the fourth coolant line 302.

The coolant whose temperature is increased through heat-exchange with the refrigerant in the condenser 13 may be supplied to the heater core 300.

In other words, the condenser 13 may supply the third coolant whose temperature is increased through exchanging heat with the refrigerant to the heater core 300 through the fourth coolant line 302.

In addition, the refrigerant condensed in the condenser 13 may be introduced into the heat-exchanger 14. The heat-exchanger 14 may exchange heat between the second coolant supplied from the battery module 200 through the second coolant line 104 by passing through the chiller 20 and the refrigerant, to additionally condense the refrigerant.

The refrigerant having passed through the heat-exchanger 14 may be introduced into the second expansion valve 23 along the connection line 21.

The second expansion valve 23 may expand the refrigerant introduced through the connection line 21 and supply the expanded refrigerant to the chiller 20.

The refrigerant introduced into the chiller 20 may cool the first coolant while exchanging heat with the first coolant supplied from the electrical component cooling apparatus 100 through the second coolant line 104.

The first coolant may have its temperature increased by recollecting the ambient air heat and the waste heat of the electrical component while passing through the radiator (not shown) and the electrical component. The first coolant whose temperature is increased through such an operation may be supplied to the chiller 20 and the heat-exchanger 14 along the second coolant line 104.

The heat-exchanger 14 and the chiller 20 may exchange heat between the first coolant supplied from the electrical component cooling apparatus 100 through the second coolant line 104 and the refrigerant, thereby efficiently recollecting the ambient air heat and the waste heat of the electrical component.

The first coolant having passed through the chiller 20 may additionally condense the refrigerant through heat-exchange with the refrigerant supplied to the heat-exchanger 14, while passing through the heat-exchanger 14.

In other words, the heat-exchanger 14 may additionally condense the refrigerant while exchanging heat between the first coolant supplied from the electrical component cooling apparatus 100 through the second coolant line 104 and the refrigerant supplied from the condenser 13.

In addition, the chiller 20 may evaporate the refrigerant while exchanging heat between the first coolant supplied from the electrical component cooling apparatus 100 through the second coolant line 104 and the refrigerant.

The refrigerant evaporated in the chiller 20 may be introduced into the accumulator 17 along the connection line 21 and the opened refrigerant line 11. Thereafter, the refrigerant may pass through the accumulator 17, to be introduced into the compressor 10.

In addition, the refrigerant compressed in the compressor 10 may sequentially pass through the condenser 13 and the heat-exchanger 14.

The heat pump system may repeatedly perform the above-described processes.

The opening/closing door 12a may be opened so that the ambient air introduced into the HVAC module 12 and having passed through the evaporator 16 may pass through the heater core 300.

Accordingly, the ambient air introduced from the outside may be introduced at a room-temperature state without being cooled, when passed through the evaporator 16 that is not supplied with the refrigerant. The introduced ambient air may be converted into a high-temperature state while passing through the heater core 300 and then introduced into the vehicle interior, thereby implementing heating of the vehicle interior.

As such, when heating of the vehicle interior is required, the heat pump system may increase the temperature of the refrigerant in the heat-exchanger 14 and the chiller 20 by using the ambient air heat and the waste heat of the electrical component, so that the power consumption of the compressor 10 can be reduced, and the heating efficiency can be improved.

In addition, the heat-exchanger 14 may use the first coolant in order to additionally condense the refrigerant, so that the pressure drop of the refrigerant discharged from the chiller 20 may be reduced compared to the conventional heat-exchanger exchanging heat between refrigerants having different temperatures.

As such, when the pressure drop of the refrigerant is decreased, the heat pump system may prevent the suction pressure and density of the compressor 10 from being decreased compared to a conventional scheme, and may prevent the total flow rate of the refrigerant flowing along the refrigerant line 11 from being decreased.

In addition, the heat-exchanger 14 may subcool the refrigerant condensed in the condenser 13 through heat-exchange with the second coolant, and supply the subcooled refrigerant to the chiller 20, so that the temperature of the refrigerant on inlet side of the chiller 20 can be lowered.

When the temperature of the refrigerant on the inlet side of the chiller 20 is lowered, the heat pump system may have the enthalpy difference of the chiller 20 to be significantly large, so that the ambient air heat and the waste heat of the electrical component may be recollected more smoothly and used for heating of the vehicle interior.

As such, since the heat pump system can sufficiently recollect and use the waste heat, the heating performance and efficiency may be improved while minimizing the usage of a separate electric heater.

An embodiment of the present disclosure takes an example in which the third coolant line 202 connected to the battery module 200 is closed at the time of heating of the vehicle interior, but is not limited thereto, and when the waste heat generated from the battery module 200 is also to be recollected, the third coolant line 202 may be opened.

As described above, according to a heat pump system for a vehicle according to an embodiment of the present disclosure, the vehicle interior may be heated by using the high-temperature coolant, and for subcooling of the refrigerant, the heat-exchanger 14 configured to exchange heat between the first coolant or the second coolant and the refrigerant is additionally employed instead of the conventional heat-exchanger configured to exchange heat between refrigerants having different temperatures, so that the enthalpy difference of the evaporator 16 or the chiller 20 is increased to be significantly large at the time of cooling or heating the vehicle interior, thereby improving the overall cooling and heating performance and efficiency of the system.

In addition, according to the present disclosure, the pressure drop of the refrigerant discharged from the evaporator 16 or the chiller 20 at the time of cooling or heating may be reduced, so that the overall flow rate of the refrigerant flowing through the system is increased to improve the efficiency and performance of the system.

In addition, according to the present disclosure, the thermal energy generated from the refrigerant at the time of condensing the refrigerant may be selectively heat-exchanged with the third coolant, by using the heat-exchanged high-temperature third coolant, the vehicle interior may be heated more efficiently.

In addition, according to the present disclosure, at the time of heating of the vehicle interior, by selectively using the ambient air heat, the waste heat of the electrical component, and the waste heat of the battery module 200, the heating efficiency of the vehicle may be improved, and by efficiently adjusting the temperature of the battery module 200 to achieve the optimal performance of the battery module 200, the overall travel distance of the vehicle may be increased.

In addition, according to the present disclosure, due to streamlining of the entire system, it is possible to reduce the overall manufacturing cost and weight, and improve space utilization by minimizing the number of components.

While this disclosure has been described in connection with what is presently considered to be practical embodiments of the present disclosure, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

10: compressor
11: refrigerant line
12: HVAC module
12a: opening/closing door
13: condenser
14: heat-exchanger
15: first expansion valve
16: evaporator
17: accumulator
20: chiller
21: connection line
23: second expansion valve
100: electrical component cooling apparatus
102: first coolant line
104: second coolant line
200: battery module
202: third coolant line
300: heater core
302: fourth coolant line

What is claimed is:

1. A heat pump system for a vehicle, the heat pump system comprising:
a compressor configured to compress a refrigerant;
an HVAC module including
a heater core and an evaporator connected to the compressor through a refrigerant line, and
a door configured to adjust air having passed through the evaporator to be selectively introduced into the heater core based on a cooling mode or a heating mode of a vehicle interior;
a condenser connected to the compressor through the refrigerant line, the condenser configured to condense the refrigerant;
a heat-exchanger connected to the condenser through the refrigerant line, the heat exchanger configured to exchange heat between a coolant and the refrigerant;
a first expansion valve disposed between the heat-exchanger and the evaporator and connected to the heat-exchanger and the evaporator through the refrigerant line;
a connection line including
a first end connected to the refrigerant line between the heat-exchanger and the first expansion valve, and
a second end connected to the refrigerant line between the evaporator and the compressor;
a chiller provided on the connection line, the chiller configured to adjust a temperature of the coolant by exchanging heat between the coolant and the refrigerant; and
an electrical component cooling apparatus connected to the condenser through a first coolant line, the electrical component cooling apparatus configured to enable a first coolant to flow along the first coolant line,
wherein the electrical component cooling apparatus is connected to the heat-exchanger and the chiller through a second coolant line, such that the first coolant is configured to be selectively supplied to the heat-exchanger and the chiller.

2. The heat pump system of claim 1, wherein the heat-exchanger is integrally configured with the condenser.

3. The heat pump system of claim 2, wherein the refrigerant, which is configured to flow from the compressor along the refrigerant line, is further configured to sequentially pass through the condenser and the heat-exchanger.

4. The heat pump system of claim 1, further comprising:
a second expansion valve provided on the connection line at an upstream end of the chiller; and
a battery module connected to the heat-exchanger and the chiller through a third coolant line, the battery module configured to selectively enable a second coolant to flow through the third coolant line,
wherein the heater core is connected to the condenser through a fourth coolant line, the heater core configured to enable a third coolant to selectively flow along the fourth coolant line.

5. The heat pump system of claim 4, wherein, in the cooling mode of the vehicle interior:
a portion of the refrigerant line interconnecting the compressor, the condenser, the heat-exchanger, the first expansion valve, and the evaporator is configured to be opened;
the connection line is configured to be opened by the second expansion valve;
the first coolant line is configured to be opened to allow the first coolant to be supplied to the condenser;
the second coolant line is configured to be closed;
the third coolant line is configured to be opened to allow the second coolant to be supplied to the heat-exchanger, the chiller, and the battery module;
the fourth coolant line is configured to be closed;
the first expansion valve is configured to expand the refrigerant introduced through the refrigerant line and supply the refrigerant expanded by the first expansion valve to the evaporator; and
the second expansion valve is configured to expand the refrigerant introduced through the connection line and supply the refrigerant expanded by the second expansion valve to the chiller.

6. The heat pump system of claim 5, wherein:
the heat-exchanger is configured to exchange heat between the second coolant supplied from the battery module through the third coolant line and the refrigerant; and
the chiller is configured to supply the second coolant cooled through exchanging heat with the refrigerant to the battery module through the third coolant line.

7. The heat pump system of claim 4, wherein, in the heating mode of the vehicle interior:
a portion of the refrigerant line connecting the compressor, the condenser, and the heat-exchanger is configured to be opened;
a portion of the refrigerant line connecting the first end of the connection line and the evaporator, and a portion of the refrigerant line connecting the evaporator and the second end of the connection line are configured to be closed by the first expansion valve;
the connection line is configured to be opened by the second expansion valve;
the first coolant line is configured to be closed;
the second coolant line is configured to be opened to allow the first coolant to be supplied to the condenser and the chiller;
the third coolant line is configured to be closed;
the fourth coolant line is configured to be opened;
an operation of the first expansion valve is configured to be stopped; and
the second expansion valve is configured to expand the refrigerant introduced through the connection line and supply the refrigerant expanded by the second expansion valve to the chiller.

8. The heat pump system of claim 7, wherein the condenser is configured to supply the third coolant having a temperature increased through exchanging heat with the refrigerant to the heater core through the fourth coolant line.

9. The heat pump system of claim 7, wherein the heat-exchanger and the chiller are configured to recollect an ambient air heat and a waste heat of the electrical component cooling apparatus while exchanging heat between the first coolant supplied from the electrical component cooling apparatus through the second coolant line and the refrigerant.

10. The heat pump system of claim 7, wherein the heat-exchanger is configured to condense the refrigerant condensed in the condenser while exchanging heat between the first coolant supplied from the electrical component cooling apparatus through the second coolant line and the refrigerant supplied from the condenser.

11. The heat pump system of claim 7, wherein the chiller is configured to evaporate the refrigerant while exchanging heat between the first coolant supplied from the electrical component cooling apparatus through the second coolant line and the refrigerant, and supply the refrigerant evaporated by the chiller to the compressor.

12. The heat pump system of claim 1, wherein the condenser is a water-cooled heat-exchanger configured to flow the first coolant or a third coolant.

13. The heat pump system of claim 1, wherein the heat-exchanger and the chiller are water-cooled heat-exchangers configured to flow the first coolant or a second coolant.

14. The heat pump system of claim 4, wherein the second expansion valve is an electronic expansion valve configured to selectively expand the refrigerant while controlling the flow of the refrigerant.

15. The heat pump system of claim 1, further comprising an accumulator provided on the refrigerant line between the evaporator and the compressor.

16. The heat pump system of claim 15, wherein the second end of the connection line is connected to the refrigerant line between the evaporator and the accumulator.

17. The heat pump system of claim 1, wherein the electrical component cooling apparatus 1 includes a radiator and an electrical component.

18. The heat pump system of claim 17, wherein the electrical component comprises an electrical power control apparatus, an inverter, or an on-board charger.
